(19) United States
(12) Patent Application Publication
(10) Pub. No.: US 2021/0094151 A1
(43) Pub. Date: Apr. 1, 2021

(54) BOX CLAMP AND CONNECTION BOX

(71) Applicant: FSR Inc., Woodland Park, NJ (US)

(72) Inventor: David HANSEN, Garnerville, NY (US)

(21) Appl. No.: 17/033,159

(22) Filed: Sep. 25, 2020

Related U.S. Application Data
(60) Provisional application No. 62/907,590, filed on Sep. 28, 2019.

(51) Int. Cl. B25B 5/10; H02G 3/08

(52) U.S. Cl. CPC B25B 5/102; H02G 3/081; B25B 5/103

(57) ABSTRACT

A box clamp comprising a frame member, a clamping screw passing through a portion of the frame member, a nut plate mounted on the clamping screw and movable along the clamping screw when the clamping screw is rotated, and a rocker clamp movably coupled to the frame wherein the nut plate acts on the rocker clamp to raise and extend the rocker clamp from a stowed orientation to a deployed orientation upon rotation of the clamping screw.

### FIELD OF THE INVENTION

The present invention relates to a clamp for fixing a connection box within an opening in a surface and a connection box with such clamp, more particularly, to a clamp that can be attached to a connection box and adjusted to secure the box to the surface adjacent the opening as well as a connection box comprising the clamp.

### BACKGROUND OF THE INVENTION

Connection boxes come in a variety of shapes and sizes for holding and providing users with access to connections for such things as electrical outlets, fiber optic cable connections, computer connections, audio visual cables, and the like.

To ensure that the connection boxes can withstand use in the environment they are placed, many connection boxes are adapted for mounting directly to a structural member, i.e., a wall stud, a floor or ceiling joist, a concrete floor or ceiling slab, etc. However, when such structural members are not available or are not conveniently located, connection boxes can be adapted for mounting within an opening in a surface such as in a raised floor, wall or ceiling.

When adapting a connection box for mounting in a surface opening, any number of mounting fixtures have been developed. For example, connection boxes mounted in a dropped ceiling can couple to rods extending from structural members, the rods having threaded ends for passing through an opening in the connection box and engagement by a corresponding nut. When the surface within which the connection box is to be mounted is stronger, for example in drywall or a raised wood or engineered floor, etc., and there is access to the back of the surface adjacent the opening, clamps can be used to fix the connection box to the surface itself.

In an environment where the connection box is used in a floor, the cover is preferably adapted to be flush with the flooring, allowing foot traffic over the electrical box. This environment requires the solid mounting of a connection box to avoid injury to the people stepping on it and protection of the components in the connection box.

An example of a connection box clamp as currently known in the art is shown in FIG. 1. The clamp has a screw that extends through a flange on the connection box and terminates on a tab extending from the exterior wall of the connection box. A horizontally swinging arm is threaded on the screw so that activation of the screw causes the arm to swing from a stowed orientation against the connection box to a deployed orientation extending outward from the connection box. Further activation of the screw raises the arm to the desired height.

However, the swinging clamp arm of the prior art may not realize enough friction in its threaded portion to ensure that the arm swings back into place against the connection box, so that it stays extended, trapping the connection box in the surface opening and preventing the connection box from being removed for servicing or replacement. Therefore, the need exists for a box clamp that not only creates a strong and secure mounting of the connection box to a surface, but also forcibly and positively returns the clamp to its stowed orientation to ensure the ability to remove the connection box when desired.

### SUMMARY OF THE INVENTION

The present invention is directed to a box clamp comprising a frame member, a clamping screw passing through a portion of the frame member, a nut plate mounted on the clamping screw that travels along at least a portion of the clamping screw when the clamping screw is rotated, and a rocker clamp pivotally coupled to the frame, wherein the nut plate acts on the rocker clamp to raise and extend the rocker clamp from a stowed orientation to a deployed orientation upon rotation of the clamping screw. The present invention is also directed to a connection box comprising the described box clamp.

In the preferred embodiment, the frame member is adapted for attachment to the wall of a connection box with attachment means. However, the frame member can be formed integrally as a part of the connection box so that it does not require discrete attachment to the connection box.

When the frame member is formed independently of the connection box, any suitable attachment means can be used to attach the frame member to the connection box, including removable means, such as one or more screws, bolts, pins, brackets, catches, clips, snaps, clasps and the like, or permanent means, such as welding, tacking, rivets, adhesives, or the like. The attachment means can reside on or pass through a portion of the frame member and/or the wall of the connection box, or otherwise create a bond between a portion of the frame member and a portion of the connection box to fix the box clamp to the connection box.

The frame member preferably comprises a face member having an opening in which the rocker clamp resides when pivoting from its stowed orientation to its deployed orientation, with one or more adjacent tracks into which a portion of the rocker clamp extends for stabilizing travel of the rocker clamp. In a preferred embodiment, the rocker clamp comprises tabs on opposed sides that ride in corresponding tracks on each side of the opening on the frame member. In a more preferred embodiment, the tracks are oriented on opposed frame panels extending inwardly from the face member of the frame member, and the tabs are flat with a height greater than the depth of the tabs to help maintain the positioning of the rocker clamp on the frame member during travel of the rocker clamp within the opening of the frame member.

The frame member also preferably has a top flange and a bottom flange, each extending inward from the frame face member at substantially 90 degree angles. The top and bottom flanges preferably comprise apertures in which the clamping screw rotates for adjustment of the rocker clamp, as more fully described below. In a preferred embodiment, the width of the top and bottom flanges is not greater than the connection box flange, found at the top of the connection box for resting on the exterior of the surface to which the connection box is mounted, so that the clamp, from the outermost frame face to the outermost attachment tab, does not extend farther from the connection box exterior wall than the connection box flange.

In a preferred embodiment, the top and bottom flanges also include attachment tabs, preferably at each end of both the top and bottom flanges, for attaching the box clamp to the connection box.

The nut plate preferably comprises a top surface and a threaded hole extending through the nut plate, where the threads on the clamping screw cooperate with the threads on the nut plate for the nut plate to travel upward and downward on the clamping screw when the clamping screw is rotated. In a preferred embodiment, the nut plate comprises a T-configuration with the base of the T fitting between the opposed panels on the frame and the top of the T riding adjacent the inward edges of the frame panels to help stabilize the nut plate within the panels of the frame.

Notwithstanding, the corresponding threading of the nut plate on the clamping screw and the apertures in the top and bottom flanges retaining the clamping screw on the frame member are generally sufficient to maintain the nut plate properly positioned between the panels of the frame member. In a preferred embodiment, the apertures for the clamping screw in the top and bottom flanges are aligned with the center of the opening on the face member of the frame, and the threaded hole on the nut plate is centered between the sides of the nut plate. This center positioning facilitates travel of the nut plate, and the rocker clamp associated therewith, on the clamping screw.

The rocker clamp of the preferred embodiment comprises a rocker face, rocker side panels, and tabs extending outwardly from the sides of the rocker face for engaging the tracks in the frame panels. The rocker face has an upper edge and a lower edge, the lower edge preferably having a cut out in the center to allow the rocker clamp to pivot around the clamping screw.

The rocker panels have an upper panel edge, comprising at least a first angled portion which is angled downwardly as it extends in a direction away from the rocker face, and preferably an intermediate portion and a second angled portion, which is also angled downwardly as it extends away from the rocker face. The rocker panels also comprise a lower panel edge, at least a portion of which extends substantially perpendicular to the rocker face and a notch between the upper panel edge and the lower panel edge.

In a preferred embodiment, the angle of the first angled portion is between about 5 degrees and about 60 degrees, preferably between about 15 and about 45 degrees and more preferably between about 25 and about 35 degrees, with about 30 degrees being most preferred. When used, the second angled portion is parallel to the first angled portion, with the same preferred range of angles.

The notch, in which the nut plate is positioned, preferably comprises an upper notch surface comprising a first portion having an angle which is substantially parallel to the first angled portion of the upper panel edge, i.e., angled downwardly as it extends away from the rocker face, at substantially the same angle as the first angled portion, and a lower notch surface having at least a portion that is substantially perpendicular to the rocker face. Preferably, the upper notch surface also comprises a portion that is angled upwardly as it extends away from the frame face, in an area adjacent the frame face member and inward of the downwardly angled portion, to assist the rocker clamp moving into the deployed orientation when the clamping screw is first turned.

The notch has sufficient clearance between the upper notch surface and the lower notch portion to allow the bottom surface of the nut plate to rest against the lower notch portion when the rocker clamp is in its stowed orientation and the top surface of the nut plate to support the angled first portion of the upper notch surface when the rocker clamp is in the deployed orientation. This permits the rocker clamp to pivot from a stowed orientation where the rocker face is substantially flush with the face of the frame member to a deployed orientation where the angle of the upper panel edge is substantially perpendicular to the face of the frame member. It also permits the rocker clamp to pivot from a deployed orientation to the stowed orientation by downward pressure of the bottom of the nut plate against the lower notch surface, where the end of the lower notch surface provides a pivot point to physically bring the rocker clamp into the stowed orientation.

When the upper panel edge of the rocker clamp is substantially perpendicular to the face of the frame in the deployed orientation, the upper panel surface is positioned to provide a flush engagement with the interior side of the surface to which the connection box is being mounted. In a preferred embodiment, the rocker clamp has a change of direction between the intermediate portion and the second portion of the upper notch surface to lock the upper notch surface on the top of the opening in the frame when in the fully raised position.

The preferred lower panel edge of the rocker clamp comprises at least a portion that is substantially perpendicular to the rocker face that may rest on the lower flange of the frame when in the stowed position. At the same time, or alternatively, when the rocker clamp is lowered, the bottom of the rocker clamp tabs reach the bottom of the track on the frame member panel, and the lower notch portion of the rocker clamp pivots on the bottom surface of the nut plate to draw the rocker clamp into its fully stowed orientation.

This configuration provides that when the clamping screw is rotated so that the rocker clamp travels away from the interior of the surface to which the connection box is mounted, the lower edge of the rocker panel and/or the lower notch portion forcibly presses against the lower flange or the bottom of the nut plate, respectively, to physically bring the rocker clamp into its stowed orientation, with the rocker face preferably positioned substantially flush with the frame face.

Of course, the angles of the upper and lower notch surfaces, the upper and lower panel edges, the top and bottom surfaces of the nut plate and the top and bottom flanges can be modified, as long as the result is that the stowed rocker clamp can be inserted into the surface opening during installation of the connection box and the panel upper edge of the deployed rocker clamp is substantially flush with the interior side of the surface when the connection box is mounted in the surface opening.

Moreover, the box clamp described is preferably fashioned for installation in a floor environment, so that the gravity plays a role in deployment of the rocker clamp and the bottom edge of the rocker panel assists in moving the rocker clamp back into the stowed orientation. Notwithstanding, the rocker clamp can be fashioned with a biasing means to bias the rocker clamp into one of the deployed orientation or the stowed orientation, as may be appropriate, for use of the box clamp in a wall or ceiling environment.

The component parts of the clamp of the present invention can be made out of any suitable material, depending on the environment. Notwithstanding, it is preferred that the frame, nut plate, rocker clamp and clamping screw are made of metal, and most preferably stainless steel or galvanized steel. In a preferred embodiment, each of the frame, nut plate and rocker clamp are made from flat sheet material, i.e., flat sheet metal, cut and bent to the desired shapes.

### BRIEF DESCRIPTION OF THE DRAWINGS

The attached drawings, in which like reference characters represent like parts, are intended to better illustrate a preferred embodiment of the present invention without limiting the invention in any manner whatsoever.

FIG. 1 is an example of a box clamp attached to a connection box as currently known in the prior art.

FIG. 2A is a front perspective view of a preferred embodiment of the present invention in its stowed orientation.

FIG. 2B is a rear perspective view of the preferred embodiment of FIG. 2A in its stowed orientation.

FIG. 3A is a front perspective view of a preferred embodiment of FIG. 2A in between its stowed orientation and its fully deployed orientation.

FIG. 3B is a rear perspective view of the preferred embodiment of FIG. 2A in between its stowed orientation and its fully deployed orientation.

FIG. 4A is a front perspective view of a preferred embodiment of FIG. 2A in its fully deployed orientation.

FIG. 4B is a rear perspective view of the preferred embodiment of FIG. 2A in its fully deployed orientation.

FIG. 5 is an exploded view of the box clamp of the present invention.

FIG. 6A is partial front elevation of the rocker clamp on the clamping screw.

FIG. 6B is side elevation of the rocker clamp on the clamping screw and nut plate in its stowed orientation.

FIG. 6C is side elevation of the rocker clamp on the clamping screw and nut plate in its deployed orientation.

FIG. 7 is a perspective view of a connection box with the box clamp of the present invention mounted on a side wall.

### DETAILED DESCRIPTION OF THE PREFERRED EMBODIMENT

The following description of the preferred embodiment is presented to describe the present invention without limiting the invention in any manner whatsoever.

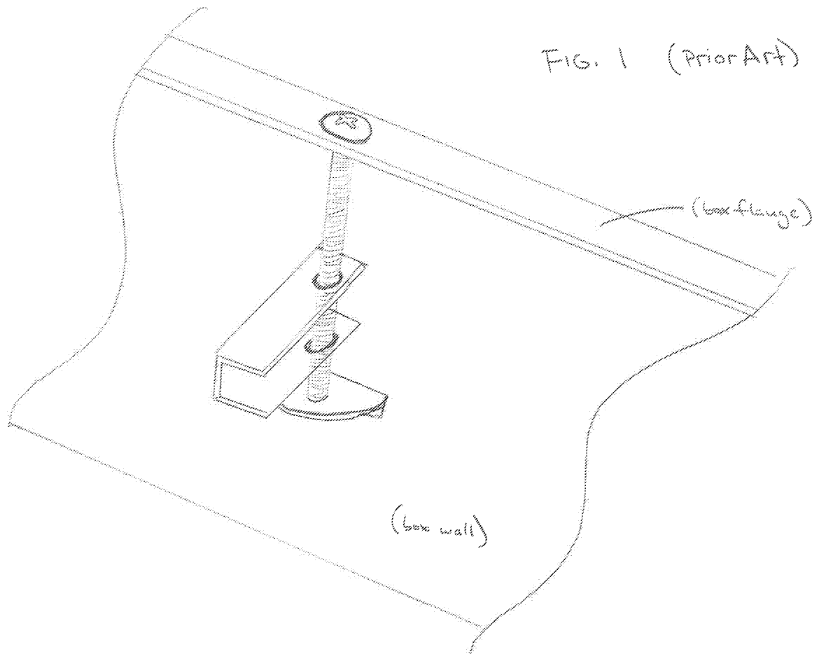

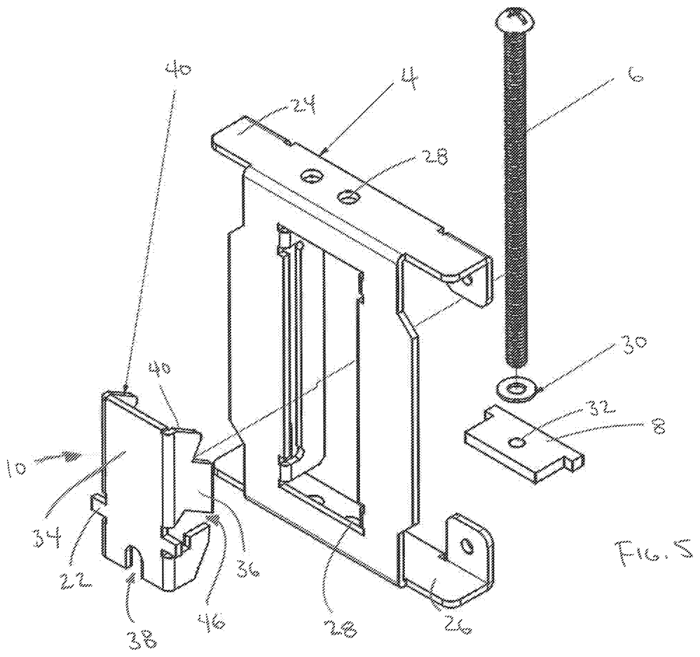

As shown in FIGS. 1-5, the present invention is directed to a box clamp 2 comprising a frame member 4, a clamping screw 6 passing through a portion of the frame member 4, a nut plate 8 mounted on the clamping screw 6 that travels along the clamping screw 6 when the clamping screw 6 is rotated, and a rocker clamp 10 pivotally coupled to the frame member 4. When the clamping screw 6 is rotated in one direction, the nut plate 8 acts on the rocker clamp 10 to raise and extend the rocker clamp 10 from a stowed orientation to a deployed orientation and, when the clamping screw 6 is rotated in the opposite direction, the nut plate 8 acts on the rocker clamp 10 to lower and retract the rocker clamp 10 from the deployed orientation to a stowed orientation.

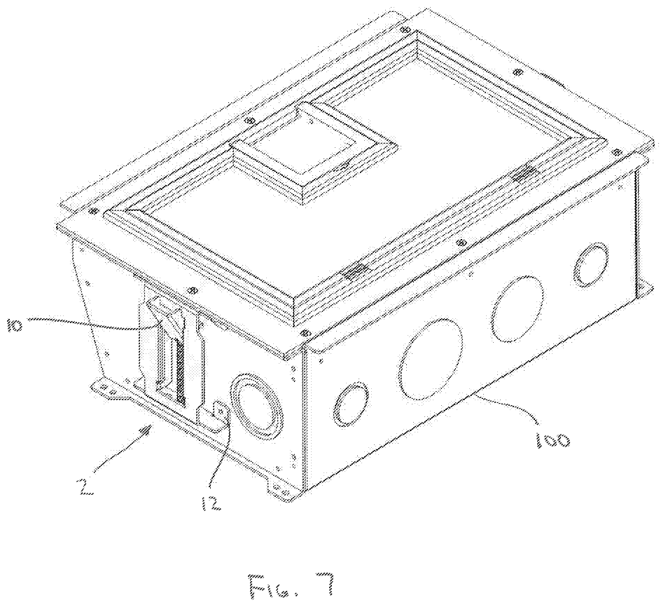

The preferred frame member 4 comprises tabs 12 for attaching the frame member 4 to a connection box 100 (see FIG. 7). Any attachment means can be used, including removable fasteners such as screws, bolts, pins, brackets, catches, clips, snaps, clasps and the like, or permanent fasteners, such as welding, tacking, rivets, adhesives, or the like. In the preferred embodiment, screws, rivets, welding or tacking attaches the frame member 4 to the connection box.

The frame member 4 preferably comprises a face member 14 having an opening 16 through which the rocker clamp 10 passes when pivoting from its stowed orientation to its deployed orientation. The frame member 4 further comprises tracks 18 on inward extending panels 20 on each side of the opening 16, in which tabs 22 extending from opposed sides of the rocker clamp 4 ride for stabilizing the rocker clamp 10 during travel. In the preferred embodiment, tabs 22 on the rocker clamp 10 are flat with a height greater than the depth to help maintain the positioning of the rocker clamp 10 on the frame member 10 during travel of the rocker clamp 10 on the frame member 4.

The frame member 4 also preferably has a top flange 24 and a bottom flange 26 extending inwardly from the face member 14, preferably at substantially 90 degree angles. The top flange 24 and bottom flange 26 comprise apertures 28 in which the clamping screw 6 rotates for adjustment of the rocker clamp, as more fully described below. The clamping screw 6 preferably has a locking nut 30 secured to the terminal end, beyond the bottom flange 26, to secure the clamping screw 6 on the frame member 4.

The width of the top flange 24 and bottom flange 26 are preferably not greater than the width of the connection box flange designed to rest on the exterior of the surface on which the connection box is mounted, so that the box clamp 2, from the outermost surface of the frame member 14 to the outermost surface of the attachment tab 12, does not extend farther from the connection box exterior wall than the connection box flange.

The preferred nut plate 8 comprises a top surface, a bottom surface and a threaded hole 32 extending therethrough, where the threads on the clamping screw 6 cooperate with the threads on the nut plate threaded hole 32 to move the nut plate 8 upward and downward on the clamping screw 6 when the clamping screw 6 is rotated. The preferred nut plate 8 has a T-configuration with the base of the T fitting between the opposed panels 20 on the frame member 4 and the top of the T riding adjacent the inward edges of the frame panels 20 to help stabilize the nut plate 8 within the panels 20 of the frame member 4.

In the preferred embodiment, the apertures 28 in the top flange 24 and bottom flange 26 are aligned with the center of the opening 16 on the frame face member 14, and the threaded hole 32 on the nut plate 8 is centered between the sides of the nut plate 8. This positioning facilitates travel of the nut plate 8, and the rocker clamp 10 that rides on the nut plate 8, on the clamping screw 6.

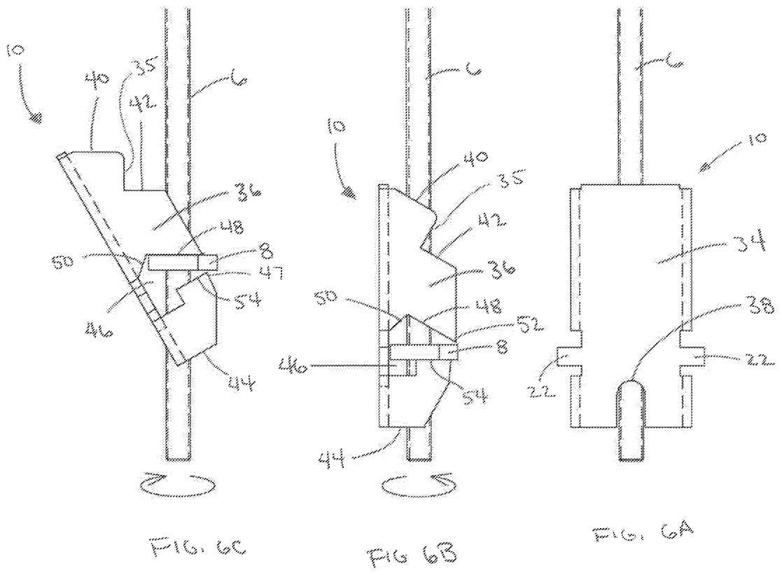

The preferred rocker clamp 10, best shown in FIGS. 6A-6B, comprises a rocker face portion 34, rocker side panels 36, and tabs 22 extending outwardly from the sides of the rocker face 34 for travel in the tracks 18 in the frame panels 28. The rocker face 34 has an upper edge and a lower edge, the lower edge preferably having a cut out 38 in the center to allow the rocker clamp 10 to pivot around the clamping screw 6.

The rocker panels 36 have an upper panel edge, preferably including an uppermost first angled portion 40 adjacent the rocker face portion 34 that angles downwardly at an angle of preferably about 25 to 35 degrees and most preferably about 30 degrees as it extends away from the rocker face portion 34, an intermediate portion 35 and a second angled portion 42 slightly lower and farther from the rocker face portion 34. The rocker panels 36 also have a lower panel edge, including a lowermost first portion 44 that preferably extends substantially perpendicular to the rocker face portion 10, and a notch 46 between the upper panel edge and the lower panel edge.

The notch 46, in which the nut plate 8 is positioned, preferably comprises an upper notch surface comprising a first upper angled portion 48, which is substantially parallel to the first angled portion 40 of the upper panel edge, and a second upper angled portion 50, which is angled upwardly as it extends between the rocker face member 34 and the first angled portion 48. As best shown in FIG. 6C, the first angled portion 48 rests on the nut plate 8 when the rocker clamp 10 is in the deployed position, while the second upper angled portion 50 aids in the rocker clamp 10 pivoting between the stowed orientation and the deployed orientation when the clamping screw 6 is turned. The outer end of the upper notch surface provides a pivot point 52 on which the rocker clamp 10 pivots between the stowed and deployed orientations.

The notch 46 also comprises a lower notch surface having a lower notch portion 54 that extends substantially perpendicular to the rocker face portion 34. As best shown in FIG. 6B, the notch 46 has sufficient clearance between the upper notch surface and the lower notch surface to allow the bottom surface of the nut plate 8 to rest against the lower notch portion 54 of the lower notch surface when the rocker clamp 10 is in its stowed orientation.

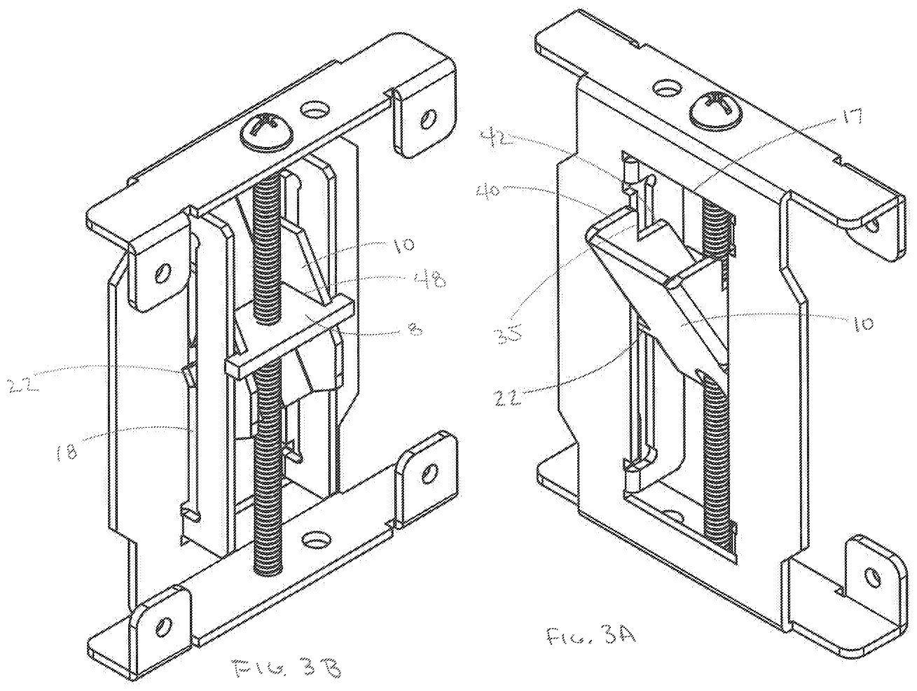

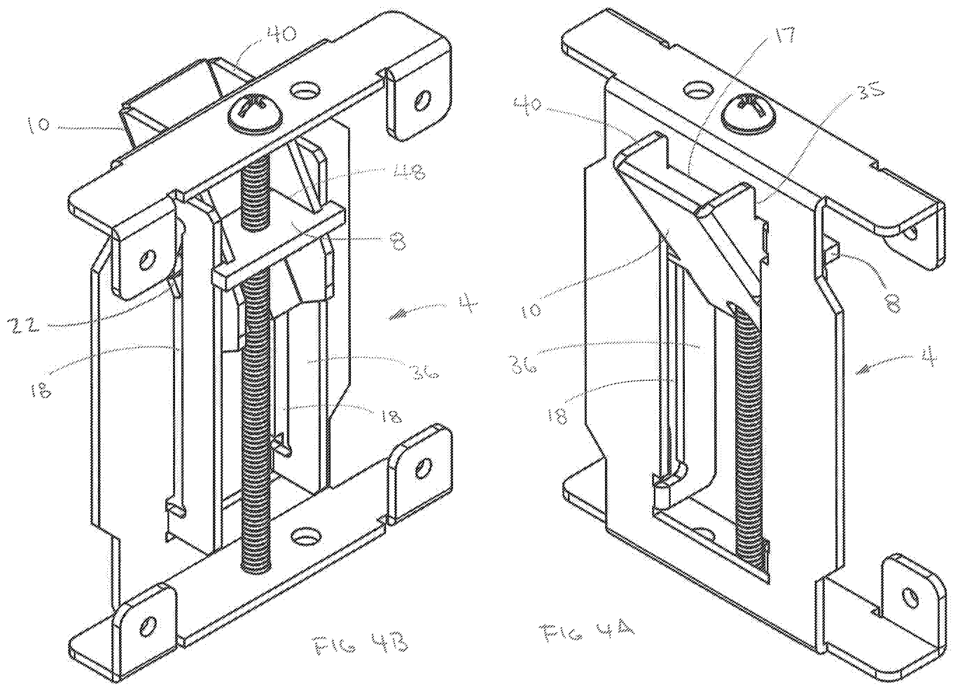

The notch 46, therefore, permits the rocker clamp 10 to pivot from the stowed orientation, where the rocker face portion 34 is substantially parallel to or flush with the frame face member 14 and the lower notch portion 54 rests against the bottom surface of the nut plate 8, to the deployed orientation, where the first angled portion 40 of the upper panel edge is substantially perpendicular to the front of the face member 14 of the frame 4 and the first angled portion 48 of the upper notch surface rests against the top surface of the nut plate 8. See FIGS. 3A and 3B where the rocker clamp 10 is fully deployed and partially raised, FIGS. 4A and 4B where the rocker clamp 10 is fully deployed and fully raised and FIGS. 6B and 6C, showing the rocker clamp 10 moving between the stowed and deployed configurations.

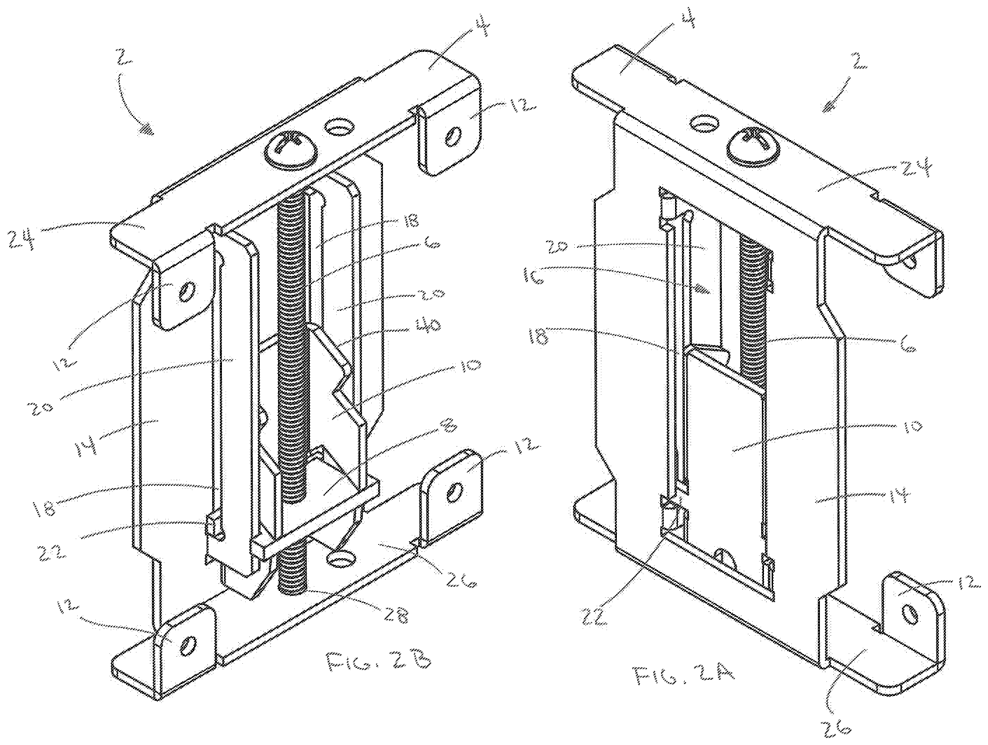

As shown in FIGS. 2A and 2b, the lowermost portion 44 of the bottom surface of the rocker panel 36, extending substantially perpendicular to the rocker face portion 34, may rest on or near the lower flange 26 of the frame member 4 when the rocker clamp 10 is in the stowed orientation. At the same time, when the rocker clamp 10 is lowered, the bottom of the tabs 22 reach the bottoms of the tracks 18 on the frame member panels 20 and the bottom of the nut plate 8 pushes against a pivot point 47 on the lower notch surface to draw the rocker clamp 10 into its fully stowed orientation.

As shown in FIGS. 2A, 2B, 6B and 6C, when the clamping screw 6 is rotated to lower the nut plate 8, so that the rocker clamp 10 moves away from the surface to which the connection box is mounted, the lowermost portions 44 of the rocker panels 36 and/or the lower portions 54 of the notch lower surface are forcibly acted upon by the lower flange 26 and/or the bottom of the nut plate 8, respectively, to physically bring the rocker clamp 10 into its stowed orientation, preferably flush with the face member 14 of the frame member 4.

As shown in FIGS. 3a and 3B, showing the rocker clamp 10 in a partially raised position, the first angled portion 40 of the upper panel edge is substantially perpendicular to the face portion 14 of the frame member 4 and parallel to the interior of the surface to which the connection box is to be mounted. This is to provide a flush engagement of the first angled portion 48 with the interior of the surface. As shown in FIGS. 4A and 4B, with the rocker clamp 10 substantially fully raised, where the first angled portion 40 of the rocker clamp 10 would be in flush contact with the interior of the surface the connection box is mounted to, a change of direction between the intermediate portion 35 and the second angled portion 42 of the upper notch surface of the rocker panel 36 locks into the top 17 of the opening 16 in the frame member 4. Once locked in the fully raised position, the rocker clamp 10 secures the connection box to the interior of the surface on which the connection box is mounted.

As set forth above, the angles of the upper and lower notch surfaces, the upper and lower panel edges, the top and bottom surfaces of the nut plate and the top and bottom flanges can be modified, as long as the result is that the stowed rocker clamp can be inserted into the surface opening during installation of the connection box and the panel upper edge of the deployed rocker clamp is substantially flush with the interior of the surface when in the deployed orientation with the connection box mounted in the surface opening. Notwithstanding, this detailed description describes the most preferred embodiment.

The frame member 4, nut plate 8, rocker clamp 10 and clamping screw 6 of the box clamp 2 are preferably made of metal, and most preferably stainless steel or galvanized steel. In the preferred embodiment described, each of the frame member 10, nut plate 8 and rocker clamp 10 are each made from a single sheet of material, cut and bent to create the desired features.

When mounted on a side wall of the connection box 100, as shown in FIG. 7, the deployed rocker clamp 10 of the box clamp 2 extends away from the side wall of the connection box 100 to engage the interior of the surface on which the connection box 100 is mounted, i.e., the underside of a floor.

In one embodiment, where one side of the connection box 100 is placed against a support that the connection box 100 can be attached to, i.e., a stud or a joist, providing a box clamp 2 on one side wall opposite the support may be sufficient to hold the connection box 100 on the interior of the surface. In another embodiment, the connection box 100 has a box clamp 2 on each of two opposed side walls, so that both sides of the connection box 100 can be secured to the interior surface. Other alternatives provide for box clamps 2 on three or more side walls, four side walls, and/or more than one box clamp 2 on at least one side wall of the connection box 100, to accommodate larger connection boxes 100 or for a more secure installation.

Variations, modifications and alterations to the above detailed description will be apparent to those skilled in the art. All such variations, modifications and/or alternatives are intended to fall within the spirit and scope of the invention, limited only by the claims. Any cited patents and/or publications are incorporated by reference.

We claim:

1. A box clamp comprising a frame member, a clamping screw passing through a portion of the frame member, a nut plate mounted on the clamping screw and movable along the clamping screw when the clamping screw is rotated, and a rocker clamp movably coupled to the frame wherein the nut plate acts on the rocker clamp to raise and extend the rocker clamp from a stowed orientation to a deployed orientation upon rotation of the clamping screw.

2. The box clamp of claim 1 wherein the rocker clamp has a first angled surface that extends perpendicular to a the direction of travel of the nut plate when the rocker clamp is in the fully deployed orientation.

3. The box clamp of claim 1 wherein the frame member comprises a face member having an opening through which the rocker clamp passes when pivoting from its stowed orientation to its deployed orientation.

4. The box clamp of claim 3 wherein the frame member comprises tracks on inward extending panels on each side of the opening in which tabs extending from opposed sides of the rocker clamp ride during movement of the rocker clamp between its stowed and deployed orientations.

5. The box clamp of claim 1 wherein each of the frame, nut plate and rocker clamp are made from flat sheet material, cut and bent to shape.

6. The box clamp of claim 1 wherein the nut plate comprises a top surface, a bottom surface and a threaded hole extending therethrough, where the threads on the clamping screw cooperate with the threads on the nut plate threaded hole to move the nut plate upward and downward on the clamping screw.

7. The box clamp of claim 1 wherein the nut plate has a T-configuration with a base of the T fitting between opposed panels on the frame member and a top of the T riding adjacent inward edges of the panels.

8. The box clamp of claim 3 wherein the frame member further comprises a top flange and a bottom flange, each of the top flange and bottom flange comprising an apertures aligned with the center of the opening on the frame face member and a threaded hole centered on the nut plate.

9. The box clamp of claim 1 wherein the rocker clamp comprises a rocker face portion comprising an upper edge and a lower edge.

10. The box clamp of claim 9 wherein the lower edge of the rocker face portion has a cut to allow the rocker clamp to pivot around the clamping screw.

11. The box clamp of claim 1 wherein the rocker clamp comprises a rocker face portion and a rocker panel adjacent the rocker face portion, the rocker panel having an upper panel edge comprising a first angled portion that angles downwardly away from the rocker face portion, an intermediate portion and a lower panel edge comprising a second angled portion that extends substantially perpendicular to the rocker face portion.

12. The box clamp of claim 11 wherein the rocker panel further comprises a notch between the upper panel edge and the lower panel edge in which the nut plate is positioned, the notch comprising an upper notch surface with a first upper angled portion substantially parallel to the first angled portion of the upper panel edge and a second upper angled portion which is angled upwardly as it extends between the rocker face portion and the first angled portion.

13. The box clamp of claim 12 wherein the first angled portion rests on the nut plate when the rocker clamp is in the deployed position and the second upper angled portion aids in the rocker clamp pivoting between the stowed orientation and the deployed orientation when the clamping screw rotated, wherein an outer end of the upper notch surface provides a pivot point on which the rocker clamp pivots between the stowed and deployed orientations.

14. The box clamp of claim 11 wherein the notch further comprises a lower notch surface having a lower notch portion that extends substantially perpendicular to the rocker face portion, the notch having sufficient clearance between the upper notch surface and the lower notch surface to allow the bottom surface of the nut plate to rest against the lower notch portion of the lower notch surface when the rocker clamp is in its stowed orientation.

15. The box clamp of claim 11 wherein the notch has an upper notch surface and a lower notch surface, wherein the lower notch surface engages a bottom surface of the nut plate when in the stowed orientation and the upper notch surface engages an upper surface of the nut plate when in the deployed orientation.

16. A connection box comprising one or more side walls, said connection box comprising a box clamp on at least one side wall, said box clamp comprising a frame member, a clamping screw passing through a portion of the frame member, a nut plate mounted on the clamping screw and movable along the clamping screw when the clamping screw is rotated, and a rocker clamp movably coupled to the frame wherein the nut plate acts on the rocker clamp to raise and extend the rocker clamp from a stowed orientation to a deployed orientation upon rotation of the clamping screw.

17. The connection box of claim 16 wherein the connection box comprises at least two opposed side walls with at least one of said box clamp on each opposed side wall.

18. The connection box of claim 16 wherein the frame member of the box clamp is coupled to a side wall of the connection box.

19. The connection box of claim 16 wherein the frame member is coupled to a side wall of the connection box by a removable fastener taken from the group consisting of screws, bolts, pins, brackets, catches, clips, snaps and clasps, a permanent fasteners taken from the group consisting of welding, tacking, rivets and adhesives and/or combinations of removable and permanent fasteners.

20. The connection box of claim 16 wherein the frame member is an integral part of the side wall of the connection box.
